(19) United States
(12) Patent Application Publication
(10) Pub. No.: US 2013/0060281 A1
(43) Pub. Date: Mar. 7, 2013

(54) Multilayer One-Piece Pacifier

(71) Applicant: Chi Shing Lam, Central (HK)

(72) Inventor: Chi Shing Lam, Central (HK)

(73) Assignee: GREAT FORTUNE (HK) LIMITED, Central (HK)

(21) Appl. No.: 13/697,952

(22) PCT Filed: May 14, 2010
(86) PCT No.: PCT/CN10/72780

§ 371 Date: Nov. 14, 2012

(30) Foreign Application Priority Data
May 14, 2010 (CN) PCT/CN2010/072780

(51) Int. Cl. A61J 17/00; B32B 37/24; B29C 70/00

(52) U.S. Cl. 606/234; 264/250; 156/242

(57) ABSTRACT

A pacifier comprises a first layer (100) having a first substrate (110) with a first surface (112) on one side and a second surface (114) on the opposite side, and having a nipple (120) extending vertically from the first surface (112) of the substrate (110); and a second layer (200) molded onto the second surface (114) of the first substrate (110), said second layer (200) forming a body portion (400) which covers less than all the second surface (114) of the first layer (100). The first substrate (110) further has two raised segments (116) in symmetry on an outer periphery thereof to form a shield portion (130), and the two raised segments (116) are dimensioned and shaped such that the shield portion (130) is rigid enough to permit no sucking of the pacifier into a baby's mouth when the two raised segments (116) are forced to abut against the body portion (400).

### FIELD OF THE INVENTION

This invention relates generally to the field of pacifiers, and more particularly, to multilayer one-piece pacifiers to provide various patterns of decoration and various functions while fulfill the safety requirement for pacifiers.

### BACKGROUND OF THE INVENTION

A pacifier is an article with a nipple intended for a young child to suck on, but that is not designed to help a baby to obtain fluid. The pacifier usually has a shield at the base of the nipple that keeps the pacifier from being sucked completely into a child's mouth. Usually, the nipple is made of a flexible and elastic material, such as latex or silicone, to mimic mother's breast, and the shield is made of a relatively rigid material, such as polypropylene (PP) or thermoplastic elastomer (TPE), to provide the sufficient strength to satisfy for example the safety requirements for pacifiers under 16 C.F.R. Part 1511 in U.S.A. Numerous prior art pacifiers/soothers are proposed for this purpose.

US 2003/0100922 discloses a one-piece pacifier that has two substrates in which the second or outer substrate overmolds onto the first or inner substrate. The two substrates form a shield and the outer substrate forms the nipple. In this patent application, the inner substrate is made of a rigid material and the outer substrate is made of an elastomeric material, in order to provide the shield with the necessary rigidity, and the nipple with the desired flexibility.

WO 2009/053699 relates to a soother comprising a relatively flexible teat portion and a relatively rigid mount portion wherein the teat portion is co-moulded to at least part of the mount portion to form an attachment therebetween. The soother disclosed in this patent application is also made by a flexible material for the teat and a rigid material for the mount to meet the safety and flexibility requirements.

Other pacifiers/soothers have been disclosed in U.S. Pat. No. 6,695,869, WO 2007/028971, WO 2009/0248074, and WO 2009/123686. However, the pacifiers/soothers in existence are hard to be well-patterned, and the patterns printed on the outer surface of the shield are vulnerable to rub off. In addition, these pacifiers/soothers are usually made of at least two materials in order to obtain a flexible nipple and a rigid shield.

While a variety of pacifiers are known in the art to fulfill their respective, particular objectives and requirements, none is available to have the shield made of a flexible and elastomeric material only to provide the sufficient strength for the pacificer. In addition, the known pacifiers do not have the ease and simplicity of displaying differently decorative effects or providing different functions according to the actual needs.

Therefore, the invention entails the task of creating a new pacifier made of a single flexible material, which is able to provide a soft and nature skin contact just like the feeling of the breast feeding and avoid the nipple rejection, while ensuring the strength and rigidity necessary for the pacifier. Moreover, the invention provides the ease and convenience of printing durable patterns, graphical designs and applying or attaching a desirable functional component.

### SUMMARY OF THE INVENTION

The present invention has been developed to fulfill the needs noted above and therefore has a principle object of the provision of a pacifier which fulfills the safety requirement for pacifiers while being soft to mimic mother's breast.

Another object of the invention is to provide a pacifier onto which a variety of desirable characters, patterns or graphical designs can be applied and are not easy to be rubbed off.

A yet further object of the invention is to provide a pacifier inside which various functional components are arranged.

These and other objects and advantages of the invention are satisfied by providing a pacifier according to a first aspect of the invention, comprising:

a first layer having a first substrate with a first surface on one side and a second surface on the opposite side, and having a nipple extending vertically from the first surface of first the substrate; and

a second layer molded onto the second surface of the first substrate, said second layer forming a body portion which covers less than all the second surface of the first layer;

wherein the first substrate further has two raised segments in symmetry on an outer periphery thereof to form a shield portion, and the two raised segments are dimensioned and shaped such that the shield portion is rigid enough to permit no sucking of the pacifier into a baby's mouth when the two raised segments are forced to abut against the body portion.

According to a second aspect, the invention provides a pacifier, comprising:

a first layer having a first substrate with a first surface on one side and a second surface on the opposite side, and having a nipple extending vertically from the first surface of the first substrate; and

a second layer molded onto the second surface of the first substrate and having a second substrate and a body portion extending vertically from the second substrate, said second substrate covering all the second surface of the first layer;

wherein the second substrate has two raised segments in symmetry on an outer periphery thereof and is molded with the first substrate to form a shield portion, and the two raised segments are dimensioned and shaped such that the shield portion is rigid enough to permit no sucking of the pacifier into a baby's mouth when the two raised segments are forced to abut against the body portion.

In one preferred embodiment, the first and second layers are formed with a same elastomeric material of same grade and/or same hardness. The elastomeric material is advantageously selected from silicone or thermoplastic elastomer.

Due to the multilayer structure of the pacifier, the first and second layers may be formed to have different colors, transparencies and textures to exhibit amusing appearance.

At least one further layer may be molded onto an outer surface of the second layer, if necessary.

Preferably, the nipple of the pacifier is a hollow nipple, and at least one air vent extending from the inside of the hollow nipple through the body portion towards the atmosphere is provided for allowing air inside the hollow nipple to be released.

In order to provide the pacifier with more functions and/or variability in its appearance, at least one component with or without desirable characters, patterns or graphical designs on a topmost surface of the component may be firmly arranged inside the pacifier. For example, the component may be attached to the first layer of the pacifier, then the second layer of the pacifier is molded onto the first layer to cover the component. Examples of the components are selected from the group consisting of metal component, wood component, plastic component, crystal component, paper component, fabric component, cardboard component, label component, lenticular component, thermometer component, electronic component, blow mold water or air bag, ring/handle, or a combination thereof.

Likewise, desirable characters, patterns or graphical designs may be formed on the second surface of the first layer, then covered and protected by the clear second layer. By doing this, the characters, patterns or graphical designs are not easy to be rubbed off. In one embodiment of the invention, the desirable characters, patterns or graphical designs are provided in the form of raised characters, patterns or graphical designs on the second surface of the first layer, and the second layer is molded to flush with the raised characters, patterns or graphical designs.

According to a third aspect of the invention, a method for producing a pacifier, comprising the steps of:

a) molding a first layer which has a first substrate with a first surface on one side and a second surface on the opposite side and has a nipple extending vertically from the first surface of the first substrate, the first substrate further having two raised segments in symmetry on an outer periphery thereof to form a shield portion;

molding a second layer onto the second surface of the first substrate, said second layer forming a body portion which covers less than all the second surface of the first layer;

wherein the two raised segments are dimensioned and shaped such that the shield portion is rigid enough to permit no sucking of the pacifier into a baby's mouth when the two raised segments are forced to abut against the body portion.

According to a fourth aspect of the invention, a method for producing a pacifier, comprising the steps of:

a) molding a first layer which has a first substrate with a first surface on one side and a second surface on the opposite side and has a nipple extending vertically from the first surface of the first substrate;

b) molding a second layer onto the second surface of the first substrate, said second layer having a second substrate that covers all the second surface of the first layer and having a body portion extending vertically from the second substrate, said second substrate having two raised segments in symmetry on an outer periphery thereof and forming a shield portion together with the first substrate of the first layer;

wherein the two raised segments are dimensioned and shaped such that the shield portion is rigid enough to permit no sucking of the pacifier into a baby's mouth when the two raised segments are forced to abut against the body portion.

The method of the invention may further comprises a step of attaching at least one component with or without desirable characters, patterns or graphical designs on a topmost surface thereof to the first layer before performing step b). The attaching may be implemented by adhesive, interlocking or hot melting.

Alternatively, the method of the invention may further comprise a step of forming desirable characters, patterns or graphical designs on the second surface of the first layer before performing step b).

In contrast to the pacifiers available in the prior art, the pacifier of the invention is made to have the shield of flexible and elastomeric material, which is not the case in the prior art pacifiers. The multilayer one-piece structure of the pacifier allows for formation of a wide range of different desirable characters, patterns or graphical designs, so as to exhibit variability in configuration and/or appearance, and the characters, patterns or graphical designs are covered and protected by the clear layer, and therefore not vulnerable to rub off. The multilayer one-piece structure of the pacifier also provides the ease and simplicity of attaching a functional component inside the pacifier and cleaning the pacifier.

To have a better understanding of the invention reference is made to the following detailed description of the invention and embodiments thereof in conjunction with the accompanying drawings.

### BRIEF DESCRIPTION OF THE DRAWINGS

FIG. 1 is a top view of a pacifier constructed in accordance with a first embodiment of the invention.

FIG. 2 is a cross-sectional front view of the pacifier shown in FIG. 1.

FIG. 3 is a top view of a pacifier constructed in accordance with a second embodiment of the invention.

FIG. 4 is a cross-sectional front view of the pacifier shown in FIG. 3.

FIG. 5 is cross-sectional front view of the pacifier of FIG. 1 which is ready to enter a pacifier test fixture.

FIG. 6 is a crossing sectional front view of the pacifier of FIG. 1 which is deformed to resist the force applied to the pacifier.

FIG. 7 is a top view of a pacifier constructed in accordance with a third embodiment of the invention, showing that a component having a pattern on its top surface is arranged inside the pacifier.

FIG. 8 is a cross-sectional front view of the pacifier shown in FIG. 7.

FIG. 9 is a top view of a pacifier constructed in accordance with a fourth embodiment of the invention, showing that a metal component is arranged inside the pacifier.

FIG. 10 is a top view of a pacifier constructed in accordance with a fifth embodiment of the invention, showing that a wood component is arranged inside the pacifier.

FIG. 11 is a cross-sectional front view of the pacifier shown in FIG. 10.

FIG. 12 is a top view of a pacifier constructed in accordance with a sixth embodiment of the invention, showing that a fabric component is arranged inside the pacifier.

FIG. 13 is a cross-sectional front view of the pacifier shown in FIG. 12.

FIG. 14 is a top view of a pacifier constructed in accordance with a seventh embodiment of the invention, showing that a lenticular component is arranged inside the pacifier.

FIG. 15 is a cross-sectional front view of the pacifier shown in FIG. 14.

FIG. 16 is a top view of a pacifier constructed in accordance with an eighth embodiment of the invention, showing that a thermometer is arranged inside the pacifier.

FIG. 17 is a cross-sectional front view of the pacifier shown in FIG. 16.

FIG. 18 is a top view of a pacifier constructed in accordance with a ninth embodiment of the invention, showing that an electronic component is arranged inside the pacifier.

FIG. 19 is a cross-sectional front view of the pacifier shown in FIG. 18.

FIG. 20 is a top view of a pacifier constructed in accordance with a tenth embodiment of the invention, showing that raised letters are molded on a top surface of the second layer with the third layer being flushed with the raised letter.

FIG. 21 is a cross-sectional front view of the pacifier shown in FIG. 20.

FIG. 22 is a top view of a pacifier constructed in accordance with an eleventh embodiment of the invention, showing that different patterns are alternately formed on the shield portion of the pacifier.

FIG. 23 is a cross-sectional front view of the pacifier shown in FIG. 22.

FIG. 24 is a top view of a pacifier constructed in accordance with a twelfth embodiment of the invention, showing that a plurality of projections protrude beyond the first layer and flush with an outer surface of the second layer to form a pattern.

FIG. 25 is a cross-sectional front view of the pacifier taken along line A-A of FIG. 24.

FIG. 26 is a top view of a pacifier constructed in accordance with a thirteenth embodiment of the invention, showing that a plurality of projections protrude beyond the second layer to form a pattern and is covered by the third layer.

FIG. 27 is a cross-sectional front view of the pacifier taken along line B-B of FIG. 26.

FIG. 28 is a partial enlarged perspective view showing the pattern.

FIG. 29 is a top view of a pacifier having a handle constructed in accordance with a fourteenth embodiment of the invention.

FIG. 30 is a side view of the pacifier shown in FIG. 29.

FIG. 31 is an exploded perspective view showing one approach for fabricating the pacifier with a handle.

FIG. 32 is an exploded perspective view showing another approach for fabricating the pacifier with a rotatable handle.

In the various figures of the drawings, like reference numbers are used to designate like parts.

### DETAILED DESCRIPTION OF THE PREFERRED EMBODIMENTS

While this invention is illustrated and described in preferred embodiments, the pacifier may be produced in many different configurations, sizes, forms and materials.

Although the terms first, second, etc. may be used herein to describe various elements, components, features and/or sections, they should not be limited by these terms. These terms are only used to distinguish one element, component, feature or section from another. Thus, a first element, component, feature or section discussed below could be termed a second element, component, feature or section without departing from the teachings of the present invention.

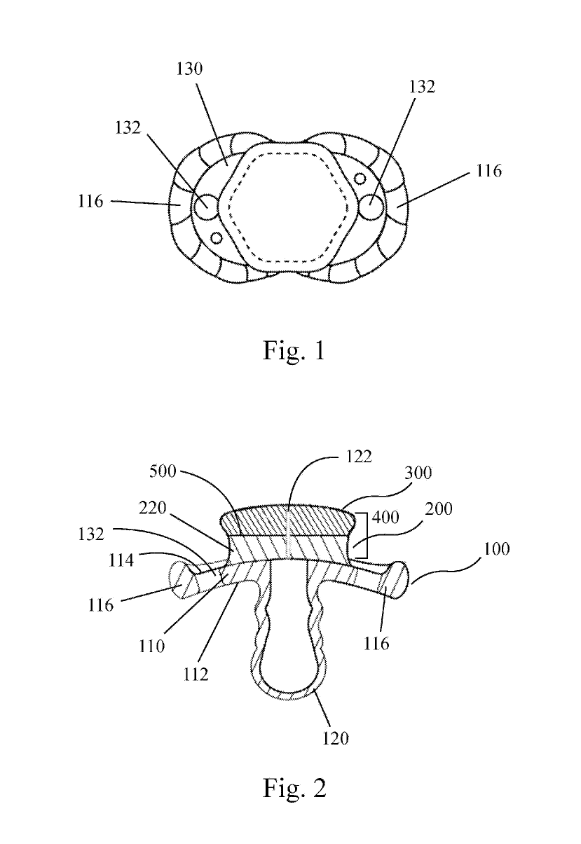

Referring now to the drawings, FIGS. 1 and 2 provide a pacifier constructed consistent with a first embodiment of the present invention. As shown in FIG. 2, this pacifier is of three-layer one-piece configuration. In this embodiment, the pacifier comprises a first layer 100 having a first substrate 110 with a first surface 112 on one side and a second surface 114 on the opposite side. A nipple 120 is extending vertically from the first surface 112 of the first layer 100. The first substrate 110 has two raised segments 116 in symmetry on an outer periphery thereof to form a shield portion 130, and the raised segments 116 take the curved shape in this embodiment.

The pacifier further comprises a second layer 200 which is molded onto the second surface 114 of the first layer 100. The second layer 200 comprises a stub 220 that covers less than all the second surface 114 of the first layer 110, which allows for positioning a plurality of ventilation holes 132 on either side of the shield portion 130. Onto a top surface of the second layer 200 are printed appealing characters, patterns or combination thereof 500 by, for example, silk screen printing or transfer printing. In this step, a variety of characters, patterns or graphical designs can be applied to the second layer 200 so that the pacifier can exhibit esthetical appearance. The characters, patterns or graphical designs are then covered by a clear or transparent third layer 300 for the purpose of providing protection for the characters, patterns or graphical designs on second layer 200 and enhancing clarity and visibility. The second and third layers form together a body portion 400 of the pacifier. The body portion 400 can be of any shape, such as circular or hexagonal shape.

The two raised segments 116 are shaped and sized such as to prevent the pacifier from being sucked into a baby's mouth when the two raised segments 116 are forced to abut against the body portion 400.

As shown in FIG. 2, the nipple 120 is a hollow nipple, and an air vent 122 is extending from the inside of the hollow nipple through the second and third layers towards the atmosphere for allowing air inside the hollow nipple to be released.

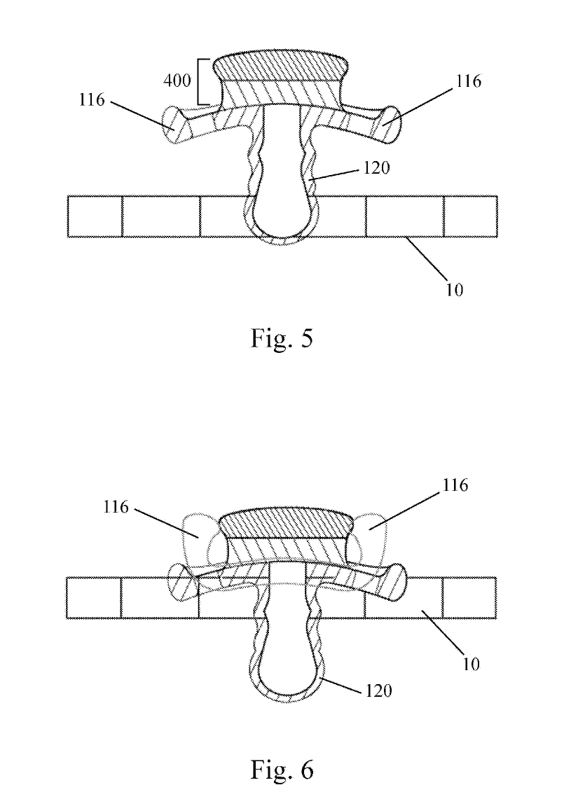

The first, second and third layers are formed with a same elastomer material of same grade and/or hardness, such as silicone or thermoplastic elastomer. The pacifier made of such an elastomer material not only has the flexibility and elasticity enough to mimic mother's breast to avoid the nipple rejection, but also comply with U.S. requirements specified in 16 C.F.R. 1511 for infant pacifiers because of the design of the symmetric raised segments 116 on the outer periphery of the shield portion. Now referring to FIGS. 5 and 6, FIG. 5 shows that the pacifier is ready to be tested on a pacifier test fixture 10 and FIG. 6 shows that the raised segments 116 are forced by a requisite force to abut against the body portion 400. This can resist the requisite force applied to the pacifier such that the pacifier does not completely go through the test fixture.

As the layers are provided individually, they can be formed to have different colors, transparencies or textures for the amusing and appealing purposes.

According to the invention, the molding of the second layer 200 onto the first layer 100 and the molding of the third layer 300 onto the second layer 200 can be implemented by co-molding, overmolding, liquid injection molding and compression molding.

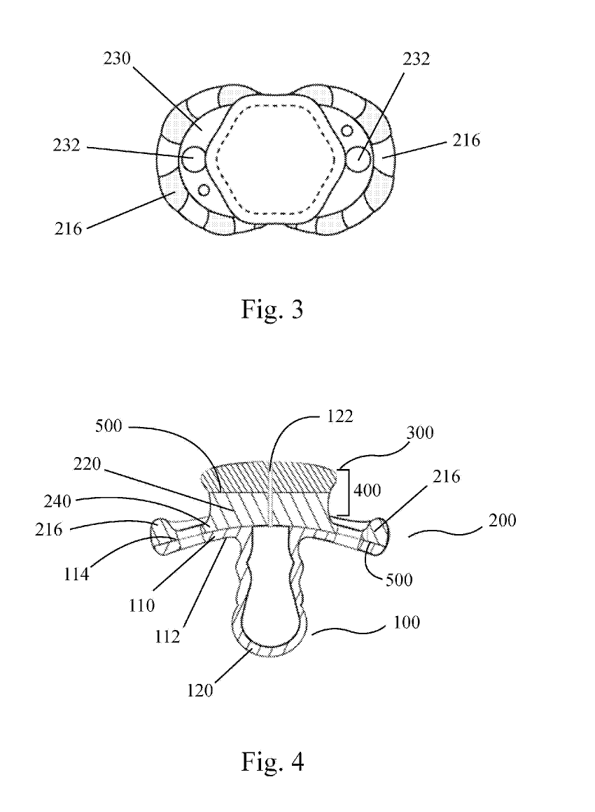

FIGS. 3 and 4 show a pacifier constructed according to a second embodiment of the invention. This pacifier is also of three-layer one-piece configuration, but differs from the one shown in the first embodiment in the shield portion 130. The pacifier comprises a first layer 100 having a first substrate 110 with a first surface 112 on one side and a second surface 114 on the opposite side. A nipple 120 is extending vertically from the first surface 112 of the first layer 100.

The pacifier further comprises a second layer 200 which is molded onto the second surface 114 of the first layer 100. In this embodiment, the second layer 200 comprises a second substrate 240 and a stub 220 extending vertically from the second substrate 240. The second substrate 240 covers all the second surface 114 of the first layer 120 and has two raised segments 216 of curved shape in symmetry on an outer periphery thereof. The second substrate 240 and the first substrate 110 are molded together to form a shield portion 230. A plurality of ventilation holes 232 are formed on either side of the shield portion 230. On a top surface of the second layer 200 are printed appealing characters, patterns or combination thereof 500 by, for example, silk screen printing or transfer printing, which are covered by a clear or transparent third layer 300 for the purpose of providing protection for the characters, patterns or graphical designs and enhancing clarity and visibility. Similarly, the characters and/or patterns 500 may be printed on the second surface 114 of the first layer 100, and in this case, the second layer is the type of clear layer. The stub 220 and the third layer 300 form together a body portion 400 of the pacifier.

Like the pacifier disclosed in the first embodiment, the two raised segments 216 are shaped and sized such as to prevent the pacifier from being sucked into a baby's mouth when the two raised segments 216 are forced to abut against the body portion 400.

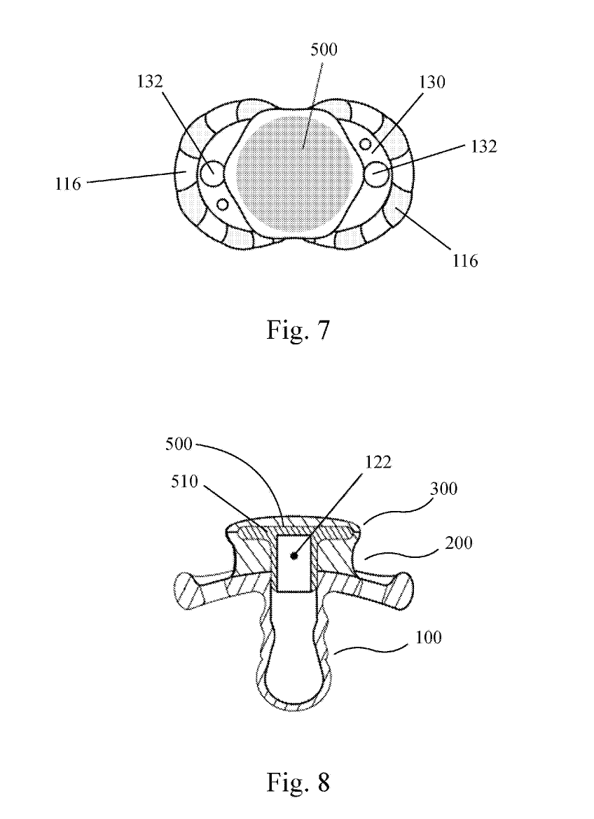

FIGS. 7 and 8 show a pacifier constructed in accordance with a third embodiment of the invention, which is a variant of the pacifier of the first embodiment. A component 510 having a pattern 500 on its top surface is placed inside the pacifier. As illustrated, the component extends from the first layer 100 through the second layer 200 into the clear third layer 300. The third layer 300 covers the pattern 500 to protect the pattern from being rubbed off and prevent the component 510 from being torn apart accidentally. An air vent 122 passes through the component 510 to communicate with the atmosphere. The component 510 may be secured to the layers by adhesive, interlocking or hot melting depending on the type and material of the component.

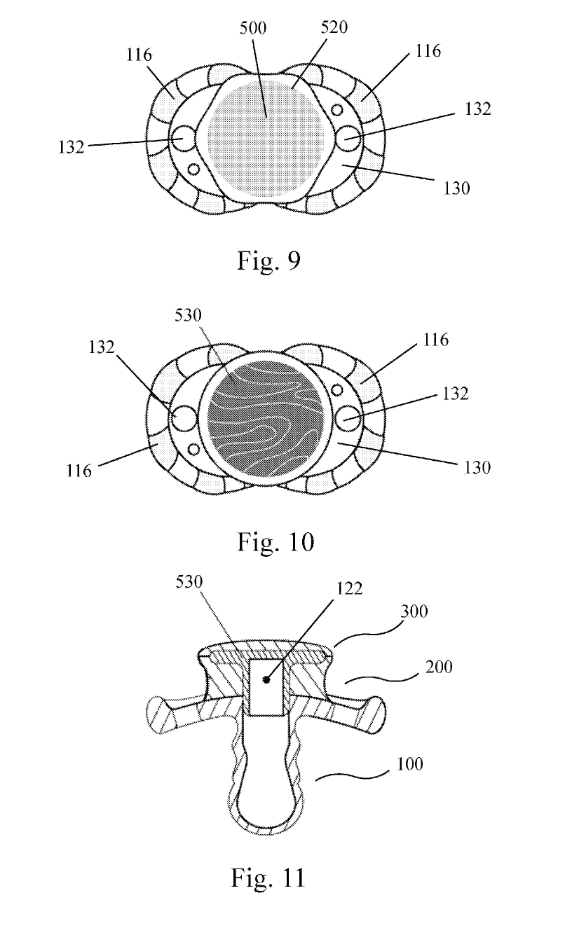

FIG. 9 shows a pacifier constructed in accordance with a fourth embodiment of the invention, which is a further variant of the pacifier of the first embodiment. This further variant is structurally same as the one shown in the third embodiment above, except that a metal component 520 is arranged inside the pacifier to provide the shinning effect of the metal.

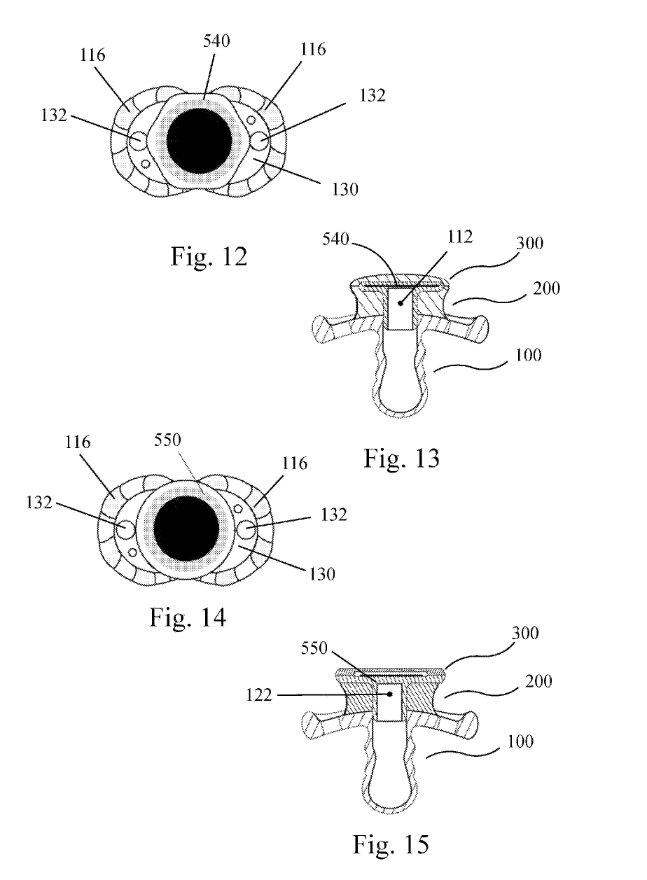

FIGS. 10 and 11 show a pacifier constructed in accordance with a fifth embodiment of the invention, which is a further variant of the pacifier of the first embodiment. This further variant is structurally same as the one shown in the third embodiment above, except that a wood component 530 is arranged inside the pacifier to provide the grain and texture of the wood.

FIGS. 12 and 13 show a pacifier constructed in accordance with a sixth embodiment of the invention, which is a further variant of the pacifier of the first embodiment. This further variant is structurally same as the one shown in the third embodiment above, except that a fabric component 540 is arranged inside the pacifier. In this embodiment, the fabric component is arranged by laminating, sticking or gluing. Again, the fabric component can be provided with desirable patterns and/or graphics. In addition to the fabric component, cardboard, label components are possible.

FIGS. 14 and 15 show a pacifier constructed in accordance with a seventh embodiment of the invention, which is a further variant of the pacifier of the first embodiment. This further variant is structurally same as the one shown in the third embodiment above, except that a lenticular component 550 is arranged inside the pacifier to provide desirable patterns and/or graphics.

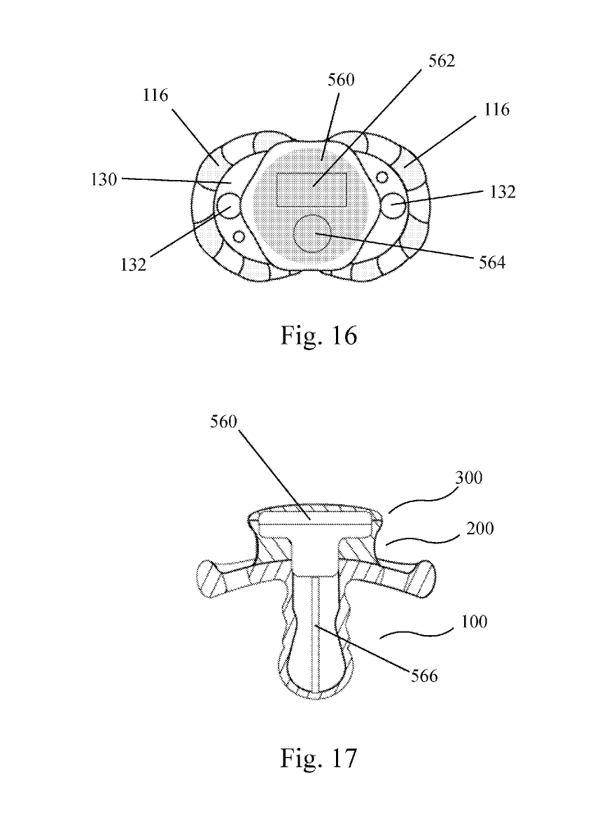

FIGS. 16 and 17 show a pacifier constructed in accordance with an eighth embodiment of the invention, which is a further variant of the pacifier of the first embodiment. This further variant is structurally same as the one shown in the third embodiment above, except that a thermometer 560 is arranged inside the pacifier to sense the temperature of the baby's mouth. This thermometer 560 has a miniature LCD display 562 and a switch 564 for switching on/off the thermometer 560 on a top surface thereof. The thermometer 560 further comprises a sensor 566 which is extending inside the hollow nipple. The thermometer 560 is waterproof as it is completely covered by the third layer 300. Pressing the third layer 300 enables to get access to the switch 564 which then powers on the thermometer 560.

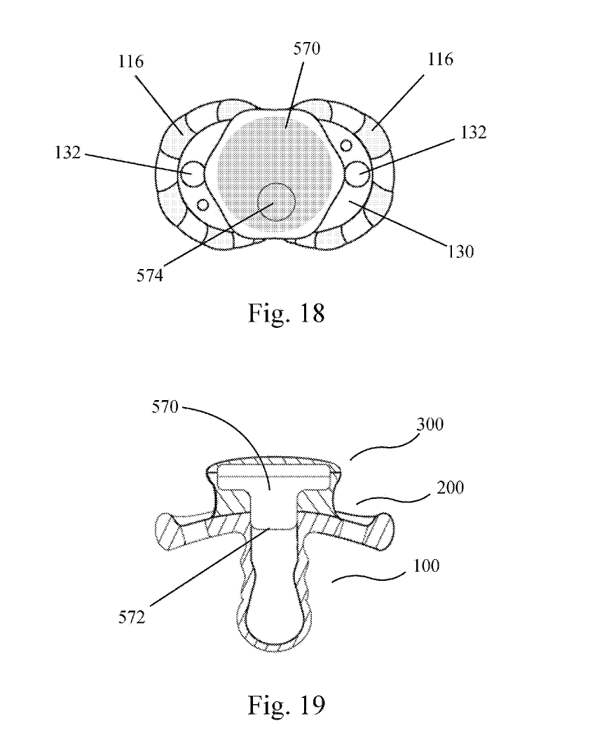

FIGS. 18 and 19 show a pacifier constructed in accordance with a ninth embodiment of the invention, which is a further variant of the pacifier of the first embodiment. This further variant is structurally same as the one shown in the third embodiment above, except that an electronic component 570, such as audio, video electronic element, motion trigger electronic light or sound, switch trigger electronic light or sound, is arranged inside the pacifier to provide various electronic functions. This electronic component 570 has a switch 574 for switching on/off the electronic component 570 on a top surface thereof. The electronic component 570 may further have a LED 572 to emit colorful light. The electronic component 570 is also waterproof as it is completely covered by the third layer 300. Pressing the third layer 300 enables to get access to the switch 574 which then powers on the electronic component 570.

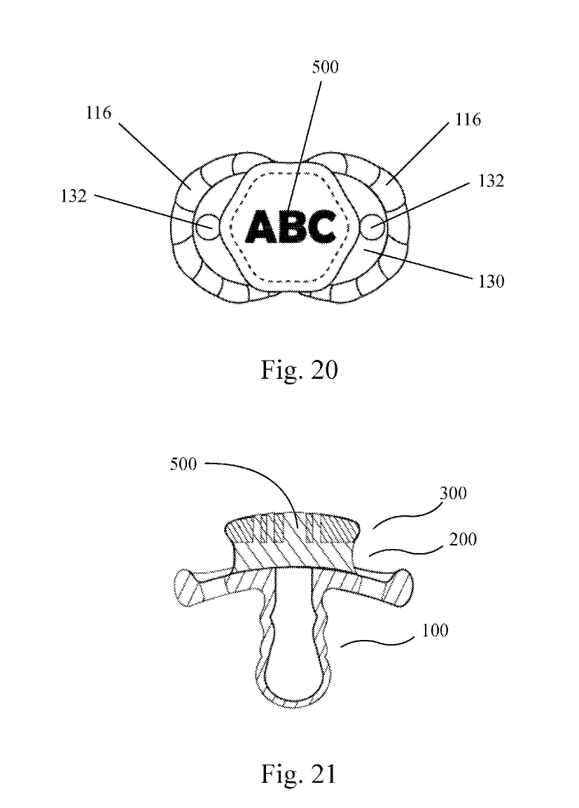

FIGS. 20 and 21 show a pacifier constructed in accordance with a tenth embodiment of the invention, which is a further variant of the pacifier of the first embodiment. This further variant is structurally same as the one shown in the first embodiment above, except that raised letters “ABC” 500 are formed on the second layer 200, and flush with the third layer 300. It is understood that the first, second and third layers can be of different colors, transparencies and textures so as to enhance decorative appearance of the pacifier.

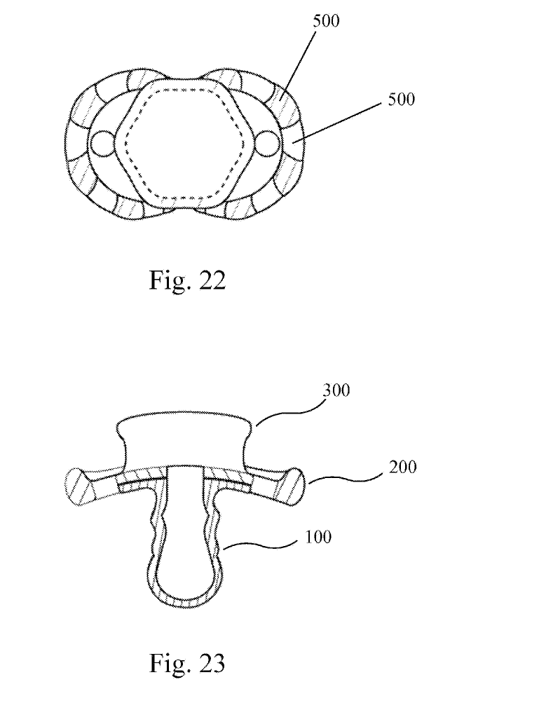

FIGS. 22 and 23 show a pacifier constructed in accordance with an eleventh embodiment of the invention, which is a further variant of the pacifier of the second embodiment. This further variant is structurally same as the one shown in the second embodiment above, except that the two raised segments 216 of the shield portion have alternately different patterns and/or graphics 500 at an equal interval.

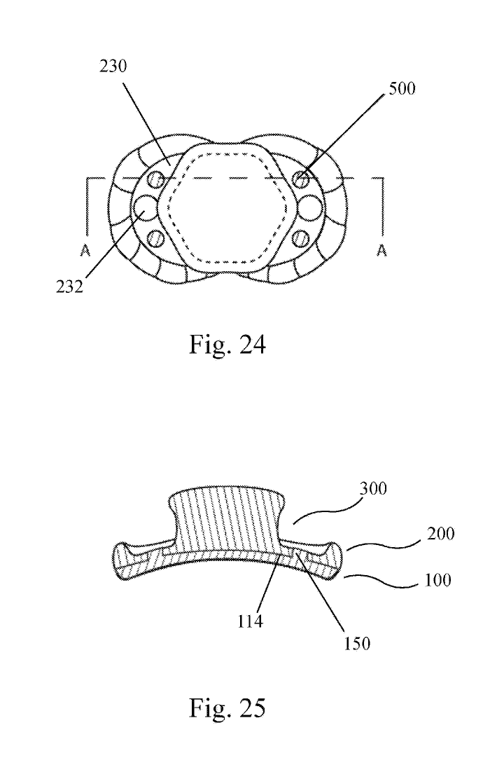

FIGS. 24 and 25 show a pacifier constructed in accordance with a twelfth embodiment of the invention, which is a further variant of the pacifier of the second embodiment. This further variant is structurally same as the one shown in the second embodiment above, except that letters, patterns and/or graphics 500 are formed by a plurality of projections 150 protruding beyond the second surface 114 of the first layer 100 and flush with the second layer 200, such that the letters, patterns and/or graphics 500 are visible on the shield portion 230.

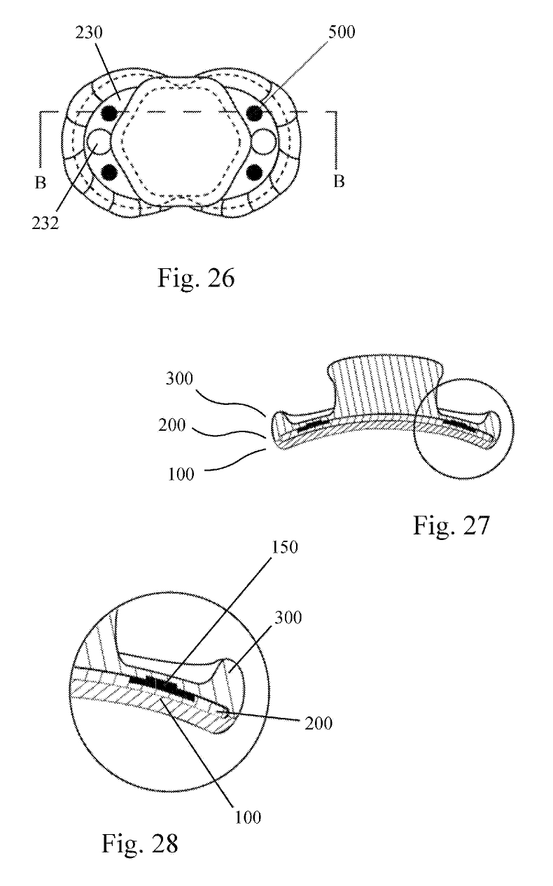

FIGS. 26 to 28 show a pacifier constructed in accordance with a thirteenth embodiment of the invention. In this embodiment, the shield portion is formed by the first layer 100, second layer 200 and third layer 300. As clearly shown in FIG. 28, letters, patterns and/or graphics 500 are formed by a plurality of projections 150 protruding beyond the second layer 200 and then covered by the clear third layer 300 such that the letters, patterns and/or graphics 500 are visible on the shield portion while protected by the third layer 300.

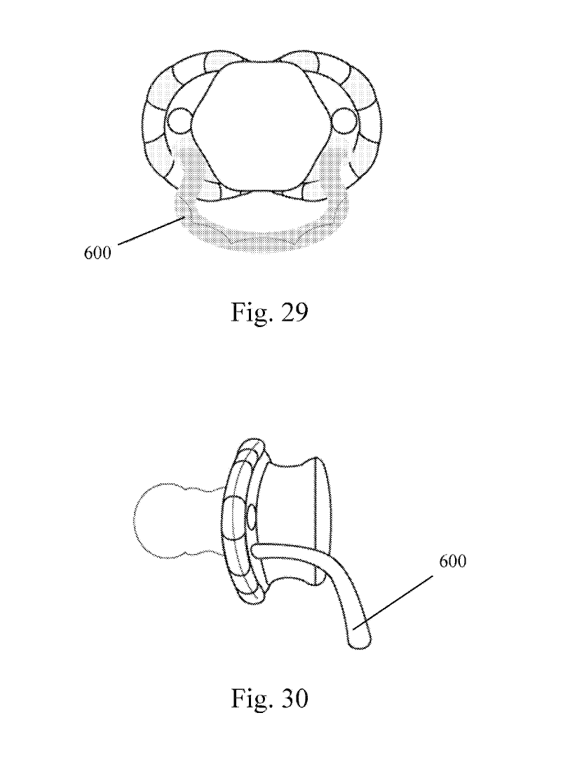

FIGS. 29 and 30 show a pacifier having a handle 600 constructed in accordance with a fourteenth embodiment of the invention, which is a further variant of the pacifier of the second embodiment. This further variant is structurally same as the one shown in the second embodiment above, except for the handle 600 which is molded inside the shield portion. The material of the handle can be the type of a material, such as Tricon, which has a good bonding to the material of the shield portion. The handle 600 facilitates the gripping of the pacifier and provides the ease of taking the pacifier away.

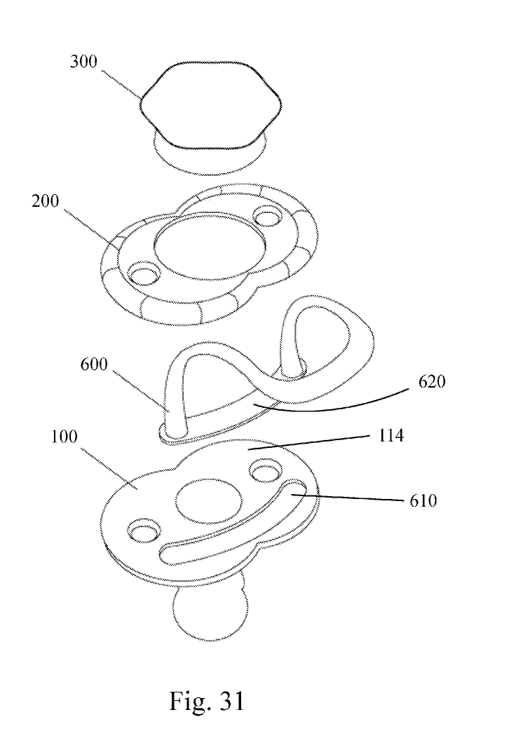

FIG. 31 is an exploded perspective view showing one approach for fabricating the pacifier with a handle. The pacifier illustrated in this figure is structurally same as the one shown in the second embodiment, except that a recess 610 is formed at one side of the second surface 114 of the first layer 100. The handle 600 has two ends which are connected by a connector 620. The connector 620 is shaped and sized to be snugly received in the recess 610. The second layer 200 and the third layer 300 are successively molded to form the pacifier after the connector 620 with the handle 600 is received in the recess 610.

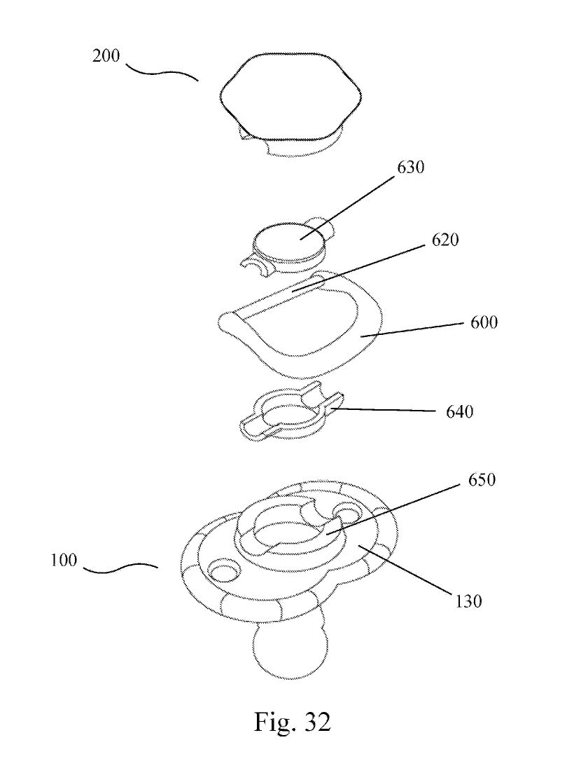

FIG. 32 is an exploded perspective view showing another approach for fabricating the pacifier with a rotatable handle. The pacifier illustrated in this figure comprises a first layer 100 which forms a shield portion 130 and a second layer 200. In order to provide a rotatable handle, an upper housing 630 and a lower housing 640 are rotatably sleeved on the connector 620 for connecting the two ends of the handle 600. The shield portion 130 has a holder 650 at the center thereof to engage with the lower housing 640 and the upper housing 630. After such an engagement, the second layer 200 is molded onto the first layer 100 to form the pacifier.

The invention thus provides a multilayer one-piece pacifier which is made of a single flexible material to provide a soft and nature skin contact just like the feeling of the breast feeding and ensure the strength and rigidity necessary for the pacifier. Moreover, the pacifier of the invention exhibits various pattern designs and functions. This invention allows for formation of distinctive and colorful patterns, characters or graphical designs on the pacifier and opens indefinite possibilities for creative and esthetical pursues.

While the embodiments described herein are intended as exemplary pacifiers, it will be appreciated by those skilled in the art that the present invention is not limited to the embodiments illustrated. Those skilled in the art will envision many other possible variations and modifications by means of the skilled person's common knowledge without departing from the scope of the invention, however, such variations and modifications should fall into the scope of this invention.

1. A pacifier, comprising: a first layer having a first substrate with a first surface on one side and a second surface on the opposite side, and having a nipple extending vertically from the first surface of the first substrate; and a second layer molded onto the second surface of the first substrate, said second layer forming a body portion which covers less than all the second surface of the first layer; wherein the first substrate further has two raised segments in symmetry on an outer periphery thereof to form a shield portion, and the two raised segments are dimensioned and shaped such that the shield portion is rigid enough to permit no sucking of the pacifier into a baby's mouth when the two raised segments are forced to abut against the body portion.

2. A pacifier, comprising: a first layer having a first substrate with a first surface on one side and a second surface on the opposite side, and having a nipple extending vertically from the first surface of the first substrate; and a second layer molded onto the second surface of the first substrate and having a second substrate and a body portion extending vertically from the second substrate, said second substrate covering all the second surface of the first layer; wherein the second substrate has two raised segments in symmetry on an outer periphery thereof and is molded with the first substrate to form a shield portion, and the two raised segments are dimensioned and shaped such that the shield portion is rigid enough to permit no sucking of the pacifier into a baby's mouth when the two raised segments are forced to abut against the body portion.

3. The pacifier as claimed in claim 1, wherein the first and second layers are formed with a same elastomeric material of same grade and/or same hardness.

4. The pacifier as claimed in claim 3, wherein the elastomeric material is selected from silicone or thermoplastic elastomer.

5. The pacifier as claimed in claim 1, wherein the first and second layers are formed to have different colors, transparencies and textures.

6. The pacifier as claimed in claim 1, wherein at least one further layer is molded onto an outer surface of the second layer.

7. The pacifier as claimed in claim 1, wherein the nipple is a hollow nipple, and at least one air vent extending from the inside of the hollow nipple through the body portion towards the atmosphere is provided for allowing air inside the hollow nipple to be released.

8. The pacifier as claimed in claim 1, wherein at least one component with or without desirable characters, patterns or graphical designs on a topmost surface thereof is arranged inside the pacifier.

9. The pacifier as claimed in claim 8, wherein the component is selected from the group consisting of metal component, wood component, plastic component, crystal component, paper component, fabric component, cardboard component, label component, lenticular component, thermometer component, electronic component, blow mold water or air bag, ring/handle, or a combination thereof.

10. The pacifier as claimed in claim 1, wherein desirable characters, patterns or graphical designs are formed between the layers.

11. The pacifier as claimed in claim 10, wherein the desirable characters, patterns or graphical designs are provided in the form of raised characters, patterns or graphical designs.

12. A method for producing a pacifier comprising the steps of: a) molding a first layer which has a first substrate with a first surface on one side and a second surface on the opposite side, and having a nipple extending vertically from the first surface of the first substrate; the first substrate further having two raised segments in symmetry on an outer periphery thereof to form a shield portion; b) molding a second layer onto the second surface of the first substrate, said second layer forming a body portion which covers less than all the second surface of the first layer; wherein the two raised segments are dimensioned and shaped such that the shield portion is rigid enough to permit no sucking of the pacifier into a baby's mouth when the two raised segments are forced to abut against the body portion.

13. A method for producing a pacifier comprising the steps of a) molding a first layer which has a first substrate with a first surface on one side and a second surface on the opposite side and has a nipple extending vertically from the first surface of the first substrate; b) molding a second layer onto the second surface of the first substrate, said second layer having a second substrate that covers all the second surface of the first layer and having a body portion extending vertically from the second substrate, said second substrate having two raised segments in symmetry on an outer periphery thereof and forming a shield portion together with the first substrate of the first layer; wherein the two raised segments are dimensioned and shaped such that the shield portion is rigid enough to permit no sucking of the pacifier into a baby's mouth when the two raised segments are forced to abut against the body portion.

14. The method as claimed in claim 12, further comprising a step of molding at least one layer onto an outer surface of the second layer.

15. The method as claimed in claim 12, wherein the first and second layers are formed with a same elastomeric material of same grand and/or same hardness, and the elastomeric material is selected from silicone or thermoplastic elastomer.

16. The method as claimed in claim 12, wherein the first and second layers are formed to have different colors, transparencies and textures.

17. The method as claimed in claim 12, further comprising a step of molding at least one air vent extending from the inside of the hollow nipple through the body portion towards the atmosphere.

18. The method as claimed in claim 12, further comprising a step of attaching at least one component with or without desirable characters, patterns or graphical designs on a topmost surface thereof to the first layer before performing step b).

19. The method as claimed in claim 18, wherein the component is selected from the group consisting of metal component, wood component, plastic component, crystal component, paper component, fabric component, cardboard component, label component, lenticular component, thermometer component, electronic component, blow mold water or air bag, ring/handle, or a combination thereof.

20. The method as claimed in claim 18, wherein the attaching is implemented by adhesive, interlocking or hot melting.

21. The method as claimed in claim 12, further comprising a step of forming desirable characters, patterns or graphical designs on the second surface of the first layer before performing step b).

22. The method as claimed in claim 21, wherein the desirable characters, patterns or graphical designs are provided in the form of raised characters, patterns or graphical designs.
